(19) United States
(12) Patent Application Publication
(10) Pub. No.: US 2004/0156195 A1
(43) Pub. Date: Aug. 12, 2004

(54) Illuminated acrylic flashlight and tool chest light utility light

(76) Inventors: Jonas J. Robertson, Harvey, LA (US); Robert M. Currie, Dollard-Des-Ormeaux (CA)

Correspondence Address: Merek, Blackmon & Voorhees, LLC, 673 S. Washington St., Alexandria, VA, 22314, US

(21) Appl. No.: 10/685,594

(22) Filed: Oct. 16, 2003

Related U.S. Application Data
(60) Provisional application No. 60/418,563, filed on Oct. 16, 2002.

(51) Int. Cl. F21L 4/00

(52) U.S. Cl. 362/186

(57) ABSTRACT

A durable light for use in extreme environments. A flashlight has an illuminated acrylic body between two end caps. Each end cap has LED lights for lighting the acrylic body. The acrylic body is hollow to allow electrical cables and control cables to pass from one end cap to the other. An outer reflective paint or resin is coated on the inner hollow chamber to disguise and hide the electric cables from the outer acrylic body. The acrylic body can be colored or treated to change the color or character of the light. A rear surface of the light can be treated with a reflective coating or tape to direct the light only outward along a desired arc of the outer perimeter of the tubular acrylic body and to shield the user from the light.

### CROSS REFERENCE TO RELATED APPLICATIONS

This application claims the benefit of U.S. Provisional Application 60/418,563, filed Oct. 16, 2003, entitled Illuminated Acrylic Flashlight and Tool Chest Light Utility Light, which is hereby incorporated by reference.

### BACKGROUND OF THE INVENTION

1. Field of the Invention

The present invention relates to a flashlight and tool chest utility light.

2. Description of the Prior Art

Flashlights are well known. The flashlights typically use fluorescent bulbs, which are easily broken, especially in the environments in which they are usually used. The lights are often used in garages, camping, and other outdoor and harsh environments where the flashlight can be bumped, dropped or struck by other objects, often resulting in breakage of the light bulb or other components on the light.

The present invention describes an apparatus and method for making an acrylic flashlight using a solid or hollow acrylic rod. The rod is lit by Light Emitting Diodes (L.E.D.). A reflective tape, white paint or co-extruded white resin can be used on one side of the rod to reflect the light to the opposite side of the rod. Other effects including grooving, sandblasting, chemical etching, or heat techniques can be used to direct and diffuse the lighting.

None of the above inventions and patents, taken either singly or in combination, is seen to describe the instant invention as claimed.

### SUMMARY OF THE INVENTION

Accordingly, it is a principal object of the invention to provide a light that is sturdy and indestructible.

It is another object of the invention to provide a flashlight having an illuminated body.

It is a further object of the invention to a flashlight that utilizes light emitting diodes instead of incandescent lighting.

Still another object of the invention is to provide a light made of acrylic and utilizing LEDs to provide a light capable of withstanding harsh environments.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is environmental perspective view of an acrylic flashlight according to the present invention.

FIG. 2A is a cross-sectional view of the acrylic flashlight having a hollow body.

FIG. 2B is a cross-sectional view of the acrylic flashlight having a solid body.

FIG. 3 is cross-sectional view of a second embodiment of the invention.

FIG. 4 is an exploded view of the parts of a third embodiment of the invention.

Similar reference characters denote corresponding features consistently throughout the attached drawings.

### DETAILED DESCRIPTION OF THE PREFERRED EMBODIMENT(s)

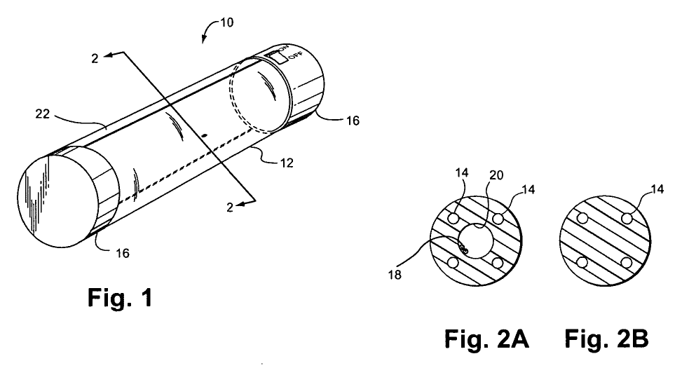

The present invention is to an acrylic flashlight for use in harsh environments. As shown in FIGS. 1 and 2, the light 10 preferably includes an illuminated body 12 having either a hollow (FIG. 2A) or solid (FIG. 2B) acrylic body and illuminated by plural LEDs 14. Opaque end caps 16 are provided at each end of the light 10 to house and hide the LEDs, batteries (not shown) and other electronics.

In the most preferred embodiment (FIG. 2A), the acrylic body is hollow to allow electric cables 18 to be passed therein so that LEDs can be provided at both ends of the light to provide an even, consistent lighting of the acrylic body. The hollow chamber inside the tube may have a white paint or co-extruded white resin to visually hide the chamber from the exterior. The white paint or resin will also help reflect the light outwardly to enhance the brightness of the light.

The LEDs may be distributed evenly around the perimeter of the acrylic tube as shown in FIGS. 2A & 2B. One skilled in the art would appreciate that the number of LED light sources can be increased or decreased for economic or functional reasons. Additionally the wattage of each LED would determine the number of LEDs necessary. In a preferred embodiment of the invention, the LEDs are high intensity light emitting diodes. Other conventional lighting such as incandescent bulbs could be used to light the acrylic body, but due to intended environment for the light, LED lighting is preferred.

To increase the apparent total power of the light, one side 22 of the acrylic body 12 is painted white or utilizes a white tape, a white backing, a co-extruded white resin or the like, to reflect a substantial portion of the light into one common direction. The white tape 22 causes the light that would reflect back towards the user to be reflected through the light out the front portion of the light. The concentration of the light through this reflector causes more of the light to be concentrated into one direction, as well as shielding the user from the backwards light rays, making it easier for the user to see in low light conditions.

The LEDs can be provided in one end cap or in both end caps. The end caps may be connected together by an electrical cable 18 to provide electricity and/or common control between the lights. The end caps may also have LED light sources that are operated independently of each other by one control or separate controls. It may also be preferably to provide the LEDs 14 in one end cap, so that the opposite un-lighted end cap can be removed to convert the light into a spotlight as light from the LEDS are directed along the length of the acrylic light and axially outward in concentrated form. In this embodiment (FIG. 2A), it may be preferably to provide lights within the radius of the hollow chamber which will illuminate without being diffused by the acrylic body 12 when the end cap is removed by shining directly through the hollow chamber. One skilled in the art would recognize that colors other than white could be used without departing from the scope of the invention.

Additionally LEDs could be provided along the length of the tube as needed to provide additional lighting to the acrylic flashlight 10. Likewise, the batteries could be provided one end cap, both end caps, or in the hollow section of the acrylic body between the end caps.

The light 10 can also be powered externally through the use of A/C or D/C voltages, though preferably any external power is converted and stepped down to between 2.0 and 4.0 Volts, and more preferably illuminates a 3.73 Volt LED. In one preferred environment, the light is powered by a cigarette lighter of an automobile and stepped down from 12 Volts to 3.73 Volts to run a light 10 mounted in a pickup truck tool chest.

The acrylic body of the flashlight lends durability to the light. The acrylic light can be dropped or bumped or struck by another object without impacting the operability of the light. Additionally the light, which would normally be clear, can be colored or otherwise treated to make the light brighter or colored for purposes such as use a policeman's safety light/baton. The acrylic body 12 could also be transparent, translucent, partially or completely opaque.

One skilled in the art would recognize that a handle or grip could be provided to make the light easier to use, position or grip.

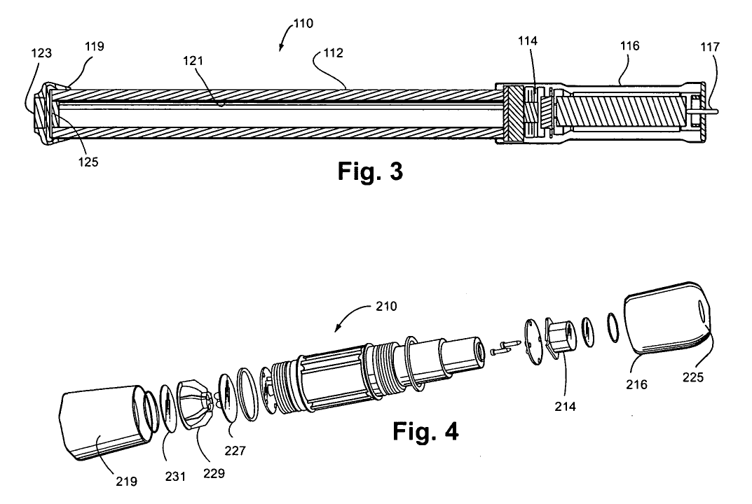

A preferred arrangement of the flashlight 110 is shown in FIG. 3. The acrylic body 112 is the preferred arrangement is hollow forming an inner chamber 121. An LED 114 is provided in communication with the inner chamber 121 of the acrylic body 112 to illuminate the body 112 from within. The LED is preferably a 1.2 watt lumiled LED, but alternate light sources may be used. Power to the LED is preferably provided by a rechargeable 3.6 DC volt Ni-Cad battery, 2200 milliamp capacity for connection to a cigarette lighter for power or charging.

The right hand end cap 116 is in the shape of an elongated handle to make the light 110 easier to use, position or grip. The handle 116 can be threaded or press fit to the acrylic tube 112. The grip is elongated to provide ample storage for batteries and other electrical components. A hook or loop 117 may be provided to connect a leash or other device for securing the flashlight or for hanging the light 110 on a hook or the like.

The body of the handle 116 and acrylic tube body 112 are preferably made of a unidirectionally opaque, polycarbonate material to provide a non-conductive, insulated battery housing and to provide a waterproof compartment for the electrical components. The polycarbonate material preferably incorporates light activated resins that amplify the tube body when subjected to a light transmission from either end. The effect is that the battery compartment or tube is non-translucent in normal use, but when the compartment is lit from its end, the tube body radiates light outwardly, that is “glows”.

One such procedure for making the unidirectional opaque (or “light activated translucent”) material is to mix a light activate resin in a hopper of acrylic or polycarbonate pellets. The pellets and resin are melted to a liquid paste and extruded through a tube dye. The resin now acts a light inhibitor blocking transmission through the material of light from external light sources. The tube viewed externally appears a solid white reflecting the light back to the viewer. When the light is applied from the inside or from a source at the ends of the tube wall, the light is diffused by the material absorbing photons from the inside so that the tube appears to glow.

Additional lighting effects can be added to the tube body 112 to change the characteristic of the tube. The tube can be frosted, or reflective stripes can be added to the inner chamber to control where and how much light goes through the acrylic tube to the exterior.

The handle 116 preferably includes an on-off switch (not shown) for controlling power to the LEDs. The switch may also contain a pulse or manual selection for flashing or signaling by pressing a button to engage power to the LEDs and releasing power when the button is released. Additionally a “strobe” setting for the on-off button can be provided to periodically strobe the light for signaling and to maximize the life of the battery.

A second end cap 119 is provided at the distal end. The end cap 119 may be made of rubber or other appropriate material. Rubber is preferred for sealing the interior chamber 121 from water or other liquids for the reason discussed further below, and to absorb impact should the light be dropped or struck by another object. Rubber is also preferred for aiding in the removal and reinsertion of the end cap 119 onto the acrylic body 112. This is important because the end cap can be removed to use the light as a spotlight as discussed above. Between the end cap 119 and the hollow chamber is preferably mounted an acrylic lens 125. The purpose of the lens is to concentrate or focus the light at a usable distance from the flashlight when used as a spotlight, and to further protect moisture from entering the chamber when the cap is removed.

The rubber end cap 119, when in position on the flashlight, preferably includes an inner light reflective surface to reflect the light back onto the acrylic body to enhance the brightness of the light. The outer portion 123 of the end cap 119 may include a pocket for receiving additional devices such as a compass (not shown) or a anti-mosquito ultrasonic frequency generator or other device. The anti-mosquito ultrasonic generator capable of repelling mosquitoes from 15 to 50 feet can be powered by the rechargeable batteries, or may supply its own power through additional batteries (not shown) or a solar power cell. The pocket may include a cover to enclose the pocket 123 or may be open to the surroundings.

Because the light is sealed from the environment by seals and construction the light can be used in wet environments. The light is weighted at one end 116 by the batteries and other electrical components. This provides the additional benefit that when the light 110 is immersed in water or other liquids, the light will float due to the light nature of plastics and the volume enclosed by the plastic. The light will float upright because the heavier end containing the batteries will weight the handle end 116 down. This will allow the light to act as a marker, lighted buoy etc. in emergency situations.

The light preferably includes a mount (not shown) for mounting to the inside of a pickup truck bed tool chest or the like. The mounting hardware is preferably translucent to provide 360 degrees (“omni directional”) light around the tool chest.

In a third embodiment of the flashlight 210 shown in FIG. 4, an end cap 219 can be provided with an opening as shown in end cap 216 at 225 in communication with a second LED 227 or group of LEDs separate from the main LED 214 to separate the flashlight and body illumination functions. A parabolic reflector 229 and lens 231 concentrate and focus the light from the LED 227 to a point outside of the flashlight. The focus point may be fixed or variable.

The end cap 219 can be removed to further concentrate light axially forward of the flashlight. Preferably the end cap 219 can be threaded to or otherwise attached to the opposed end cap 216 when not in use.

It is to be understood that the present invention is not limited to the sole embodiment described above, but encompasses any and all embodiments within the scope of the following claims.

I claim:

1. A flashlight comprising:
an acrylic rod having an end cap on each end;
at least one light mounted in communication with the acrylic rod for lighting the acrylic rod.

2. The flashlight according to claim 1, including:
a reflective layer applied to at least a portion of said acrylic rod for selective directing the light in the acrylic body towards a preselected area outside of the acrylic light.

3. The flashlight according to claim 1, wherein said at least one light is a light emitting diode.

4. The flashlight according to claim 1, wherein said at least one light is a plurality of light emitting diodes mounted to one of said end caps.

5. The flashlight according to claim 1, wherein said at least one light is a plurality of light emitting diodes mounted in a circular array within one of said end caps.

6. The flashlight according to claim 1, wherein said acrylic rod is hollow.

6. The flashlight according to claim 1, wherein further:
said acrylic rod defines a hollow chamber and
said at least one light comprises a plurality of light emitting diodes mounted at each end of said acrylic rod, and said plurality of light emitting diodes are electrically connected by electrical wires contained within said hollow chamber.

7. The flashlight according to claim 1, wherein said reflector is an acrylic paint.

8. The flashlight according to claim 1, wherein said reflector is a resin co-extruded with said acrylic rod.

9. The flashlight according to claim 1, wherein said reflector is a white tape paint.

10. The flashlight according to claim 1, wherein said reflector is an acrylic paint.

11. The flashlight according to claim 1 said at least one light comprising a plurality of lights, and at least one of said plurality of lights is colored.

12. The flashlight according to claim 12, wherein at least one of said plurality of lights is a high intensity light emitting diode.

13. The flashlight according to claim 1, wherein said acrylic rod is translucent.

14. The flashlight according to claim 1, wherein said acrylic rod is transparent.

15. The flashlight according to claim 1, wherein said acrylic rod is transparent.

16. The flashlight according to claim 1, wherein said acrylic rod is partially opaque.

17. The flashlight according to claim 1, wherein said acrylic rod is colored.
